(19) United States
(12) Patent Application Publication
(10) Pub. No.: US 2013/0285462 A1
(43) Pub. Date: Oct. 31, 2013

(54) APPARATUS AND METHOD FOR TRANSMITTING WIRELESS ENERGY IN ENERGY TRANSMISSION SYSTEM

(71) Applicant: ELECTRONICS AND TELECOMMUNICATIONS RESEARCH IN, Daejeon (KR)

(72) Inventors: Seong-Min KIM, Daejeon (KR); Jung-Ick MOON, Daejeon (KR); In-Kui CHO, Daejeon (KR); Je-Hoon YUN, Daejeon (KR); Woo-Jin BYUN, Daejeon (KR)

(73) Assignee: Electronics and Telecommunications Research Institute, Daejeon (KR)

(21) Appl. No.: 13/681,627

(22) Filed: Nov. 20, 2012

(30) Foreign Application Priority Data
Apr. 27, 2012 (KR) 10-2012-0044694

(51) Int. Cl. H01F 38/14

(52) U.S. Cl. CPC H01F 38/14
USPC 307/104

(57) ABSTRACT

An apparatus for transmitting wireless energy in an energy transmission system includes a transmission resonator block configured to have a plurality of transmission resonators arranged therein, a transmission signal generation block configured to generate an energy signal, a switch block connected to the plurality of transmission resonators and configured to switch the energy signal to the plurality of transmission resonators in response to a switching control signal, and a control block configured to generate the switching control signal for switching the energy signal to a transmission resonator including a transmission region where a receiver is placed when detecting the receiver placed in the transmission regions of the plurality of transmission resonators.

### CROSS-REFERENCE TO RELATED APPLICATIONS

The present application claims priority of Korean Patent Application No. 10-2012-0044694, filed on Apr. 27, 2012, which is incorporated herein by reference in its entirety.

### BACKGROUND OF THE INVENTION

1. Field of the Invention

Exemplary embodiments of the present invention relate to an energy transmission system and, more particularly, to an apparatus and method for transmitting wireless energy which can extend an energy transmission region in an energy transmission system.

2. Description of Related Art

In a current wireless energy transmission method used in an energy transmission system, power is transmitted using one transmission resonator. Furthermore, the energy transmission system transfers energy to one reception resonator or a plurality of reception resonators corresponding to the transmission resonator.

The method of transferring energy using one transmission resonator as described above is disadvantageous in that a region to which the energy can be transmitted is limited depending on the size of the transmission resonator. In particular, if an energy transmission system using one transmission resonator is applied to a wide area, there is a problem in that the size of the transmission resonator must be proportional to a region to which energy will be transmitted.

### SUMMARY OF THE INVENTION

An embodiment of the present invention is directed to providing an apparatus and method for transmitting wireless energy which can extend an energy transmission region in an energy transmission system.

Another embodiment of the present invention is directed to providing an apparatus and method for transmitting wireless energy which configures a wireless energy transmission network capable of transmitting wireless energy to a wide area in an energy transmission system.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for transmitting wireless energy in an energy transmission system includes a transmission resonator block configured to have a plurality of transmission resonators arranged therein; a transmission signal generation block configured to generate an energy signal; a switch block connected to the plurality of transmission resonators and configured to switch the energy signal to the plurality of transmission resonators in response to a switching control signal; and a control block configured to generate the switching control signal for switching the energy signal to a transmission resonator including a transmission region where a receiver is placed when detecting the receiver placed in the transmission regions of the plurality of transmission resonators.

In accordance with another embodiment of the present invention, a method of transmitting wireless energy in an energy transmission system includes generating an energy signal; sequentially supplying the energy signal to a plurality of transmission resonators for a specific period of time; measuring output reflection coefficients generated in response to the energy signal; detecting the position of a receiver based on the measured output reflection coefficients; and supplying the energy signal to a transmission resonator where the receiver is placed.

In accordance with another embodiment of the present invention, a method of transmitting wireless energy in an energy transmission system includes detecting the entry of a receiver into a plurality of transmission regions formed by respective transmission resonators; receiving information for generating an energy signal that is necessary for the receiver through communication with the receiver when detecting the entry of the receiver; and sending the energy signal, generated based on the received information, to the receiver.

### BRIEF DESCRIPTION OF THE DRAWINGS

FIG. 1 is a schematic diagram showing an apparatus for transmitting wireless energy in an energy transmission system in accordance with an embodiment of the present invention.

FIG. 2 is a schematic diagram showing a receiver placed in a transmission resonator block in the energy transmission system in accordance with an embodiment of the present invention.

FIG. 3 is a schematic diagram showing a process of transmitting wireless energy in the energy transmission system in accordance with an embodiment of the present invention.

FIG. 4 is a schematic diagram showing the movement of a receiver in the transmission resonator block in the energy transmission system in accordance with an embodiment of the present invention.

FIG. 5 is a schematic diagram showing a process of transmitting wireless energy when a receiver moves in the transmission resonator block in the energy transmission system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

The present invention provides an apparatus and method for transmitting energy wirelessly in an energy transmission system. The apparatus for transmitting wireless energy, proposed by the present invention, can transmit wireless energy to all electronic devices that are operated by a power source or a battery. In the present invention, an electronic device that receives energy from the apparatus for transmitting wireless energy is called a receiver.

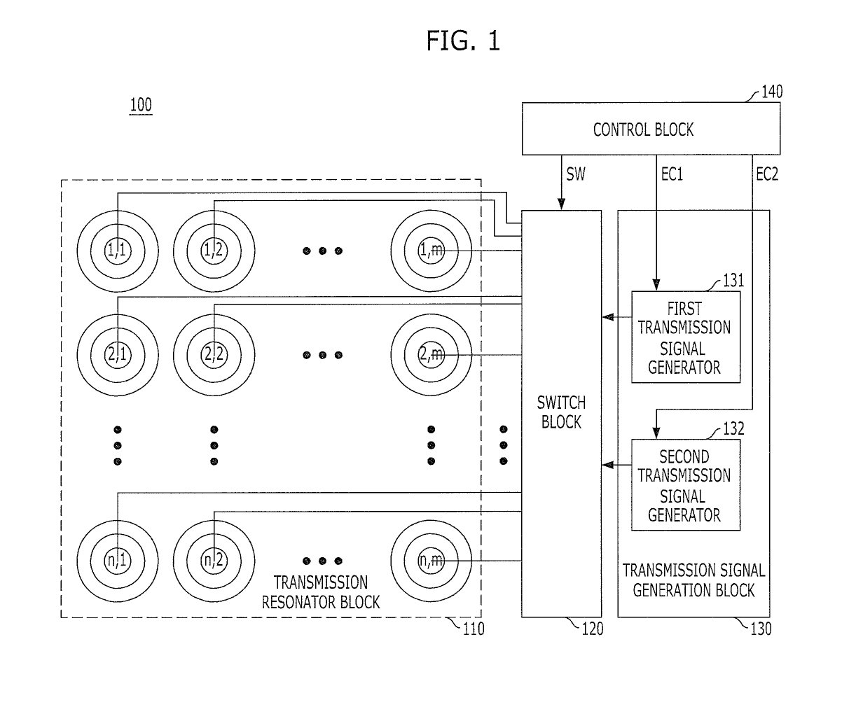

FIG. 1 is a schematic diagram showing an apparatus for transmitting wireless energy in an energy transmission system in accordance with an embodiment of the present invention.

Referring to FIG. 1, the apparatus 100 for transmitting wireless energy includes a transmission resonator block 110, a switch block 120, a transmission signal generation block 130, and a control block 140.

The transmission resonator block 110 can include a plurality of transmission resonators. Accordingly, a plurality of small-sized transmission resonators can be disposed in the transmission resonator block 110. Each of the plurality of transmission resonators sends an energy signal supplied thereto. Furthermore, each of the plurality of transmission resonators includes a transmission region for transmitting the energy signal. Thus, the transmission resonator block 110 sends energy to receivers that are placed within the respective transmission regions of the transmission resonators. To this end, the plurality of transmission resonators can be arranged so that their transmission regions do not overlap with each other to the highest degree. In this case, wireless energy transmission efficiency using the plurality of transmission resonator can become a maximum. Here, the plurality of transmission resonators can be placed in coordinates (1,1), (1,2), . . . , (1,n), (2,1), (2,2), . . . , (2,n), (n,1), (n,2), . . . , (n,m), respectively.

The switch block 120 is connected to the transmission resonators of the transmission resonator block 110. The switch block 120 receives an energy signal from the transmission signal block 130. The switch block 120 can perform a switching operation in response to a switching control signal SW generated from the control block 140 so that the received energy signal is transferred to the transmission resonators of the transmission resonator block 110. The switch block 120 can include a plurality of switches connected to the respective transmission resonators.

The transmission signal generation block 130 includes a first transmission signal generator 131 and a second transmission signal generator 132. The first transmission signal generator 131 generates a first energy signal in response to a first energy control signal Ed1, and the second transmission signal generator 132 generates a second energy signal in response to a second energy control signal EC2. The first energy signal and the second energy signal are generated for wireless energy transmission and provided to the switch block 120. The transmission signal generation block 130 including the two transmission signal generators 131 and 132 as described above can transmit seamless energy when a receiver moves between the transmission regions formed by the transmission resonators. To this end, the first transmission signal generator 131 and the second transmission signal generator 132 can perform operations for a shift between the transmission regions as the receiver moves.

Although the transmission signal generation block 130 is illustrated as including the two transmission signal generators 131 and 132, the transmission signal generation block 130 may include three or more transmission signal generators. In this case, the transmission signal generation block 130 can send wireless energy to two or more of the receivers. Meanwhile, the transmission signal generation block 130 may include one transmission signal generator for generating a plurality of energy signals.

The control block 140 generates the switching control signal SW for controlling the switch block 120 and the energy control signals EC1 and EC2 for controlling the first and the second transmission signal generators 131 and 132. The control block 140 performs an overall control operation for transmitting wireless energy to a receiver placed in the transmission resonator block 110. An overall operation of the apparatus 100 for transmitting wireless energy for transmitting wireless energy to the receiver under the control of the control block 140 is described in detail with reference to relevant drawings.

As described above, in the present invention, since wireless energy is transmitted to the receiver through the transmission resonator block 110 in which a plurality of transmission resonators is disposed, a wireless energy transmission network capable of transmitting wireless energy to a wider area can be configured. That is, the apparatus 100 for transmitting wireless energy can configure a relatively wide wireless energy transmission network as compared with one transmission resonator or transmission resonators for relaying wireless energy.

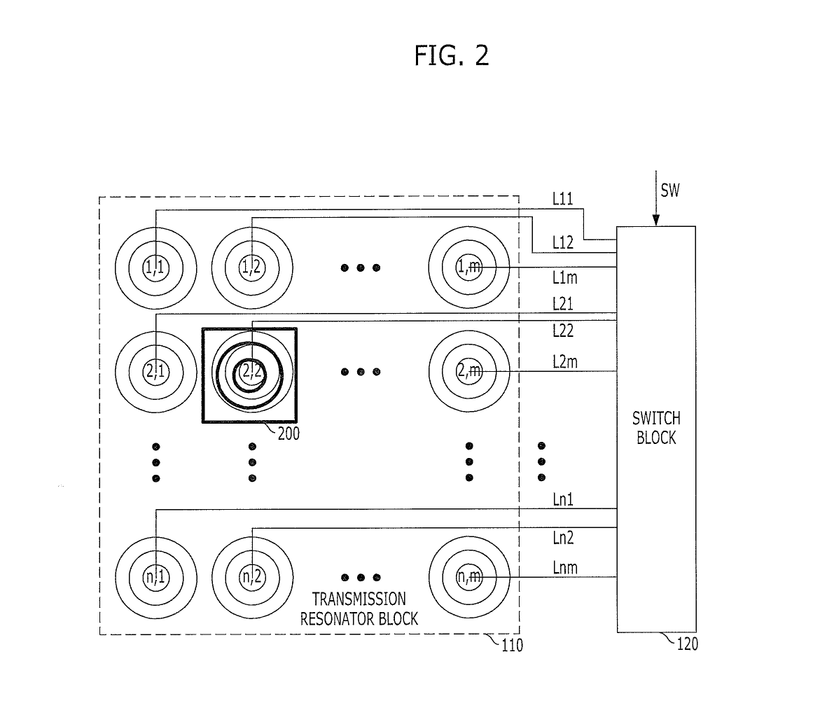

FIG. 2 is a schematic diagram showing a receiver placed in the transmission resonator block in the energy transmission system in accordance with an embodiment of the present invention.

Referring to FIG. 2, the switch block 120 is connected to a plurality of transmission resonators through transmission lines L11-Lmn in order to send an energy signal to the transmission resonators. For example, the switch block 120 is connected to a transmission resonator placed at coordinates (1,1) through the transmission line L11. The switch block 120 is connected to a transmission resonator placed at coordinates (1,2) through the transmission line L12. The switch block 120 is connected to a transmission resonator placed at coordinates (1,m) through the transmission line Llm. Furthermore, the switch block 120 is connected to a transmission resonator placed at coordinates (n,m) through the transmission line Lnm. Likewise, the switch block 120 is connected to transmission resonators placed at the remaining coordinates through the remaining transmission lines, respectively.

Here, a receiver 200 is placed in the transmission region of the transmission resonator placed at the coordinates (2,2). In this case, when the entry of the receiver 200 into the transmission region of the transmission resonator placed at the coordinates (2,2) is detected, the control block 140 sends an energy signal to the transmission resonator placed at the coordinates (2,2) through the transmission line L22. Thus, the receiver 200 can receive the energy signal.

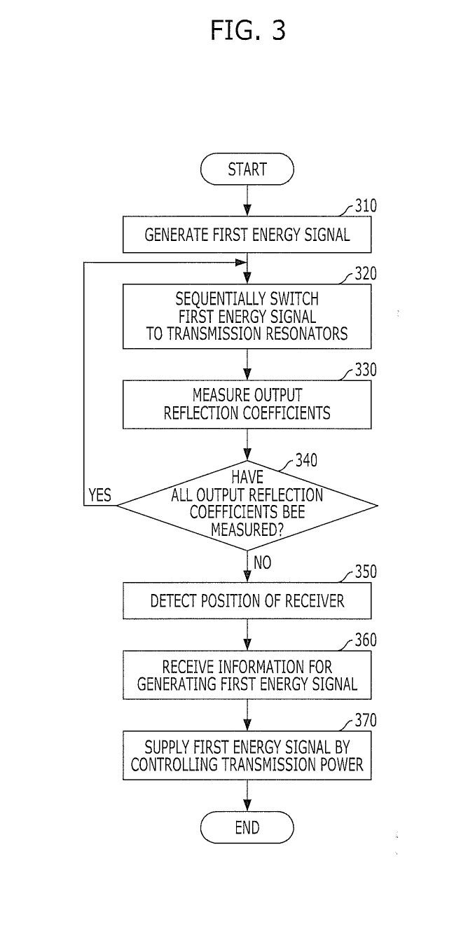

The operation of the apparatus 100 for transmitting wireless energy for providing the energy signal in response to the entry of the receiver 200 is described in detail with reference to FIG. 3 below.

FIG. 3 is a schematic diagram showing a process of transmitting wireless energy in the energy transmission system in accordance with an embodiment of the present invention.

Referring to FIG. 3, at step 310, the first transmission signal generator 131 generates a first energy signal in order to detect the entry of the receiver. The first transmission signal generator 131 outputs the first energy signal to the switch block 120. Here, the control block 140 generates the first energy control signal EC1 for generating the first energy signal. Next, the control block 140 outputs the first energy control signal Ed1 to the first transmission signal generator 131. In response to the first energy control signal EC1, the first transmission signal generator 131 is switched on, thus generating the first energy signal.

At step 320, the switch block 120 supplies the first energy signal to the plurality of transmission resonators sequentially for a specific period of time under the control of the control block 140. The switch block 120 supplies the first energy signal to all the transmission resonators in order to measure output reflection coefficients

At step 330, the control block 140 measures the output reflection coefficients in response to the first energy signal of the first transmission signal generator 131. The control block 140 measures the output reflection coefficients for the respective transmission resonators. Accordingly, the control block 140 performs control so that the first energy signal outputted from the first transmission signal generator 131 has minimum power for measuring the output reflection coefficients. Accordingly, power unnecessarily consumed by the apparatus 100 for transmitting wireless energy 100 can be prevented.

At step 340, the control block 140 checks whether the output reflection coefficients for all the transmission resonators have been measured in response to the first energy signal or not. If, as a result of the check, it is checked that the output reflection coefficients for all the transmission resonators have not been measured, the control block 140 proceeds to the step 320. At the step 320, the control block 140 generates the switching control signal SW so that the first energy signal is switched to a next transmission resonator. If, as a result of the check at the step 340, it is checked that the output reflection coefficients for all the transmission resonators have been measured, the control block 140 proceeds to step 350.

At the step 350, the control block 140 detects the entry of the receiver into a transmission resonator that has an output reflection coefficient having the greatest change, from among the measured output reflection coefficients of the transmission resonators. For example, it is assumed that a change of an output reflection coefficient measured by supplying the first energy signal to the transmission resonator placed at the coordinates (2,2) is the greatest. Accordingly, the control block 140 can check that the receiver 200 is placed in the transmission resonator placed at the coordinates (2,2). While detecting the entry of the receiver 200, the control block 140 turns on the first transmission signal generator 131 and turns off the second transmission signal generator 132 so that the first energy signal is supplied.

At step 360, the control block 140 receives information for generating the first energy signal from the receiver 200. The control block 140 outputs the switching control signal SW to the switch block 120 so that the first energy signal is supplied to the transmission resonator placed at the coordinates (2,2) where the receiver is placed. Here, the intensity of the first energy signal supplied to the transmission resonator placed at the coordinates (2,2) can be increased under the control of the control block 140 until a communication block within the receiver 200 operates. Accordingly, the first energy signal can supply energy for the operation of the communication block, that is, power.

When the communication block operates, the receiver 200 supplies the information for generating the first energy signal to the transmission resonator placed at the coordinates (2,2). Here, the information for generating the first energy signal includes information on an Identifier (ID) of the receiver 200, the amount of necessary energy, and the amount of received energy (i.e., the amount of energy now being received). Accordingly, the transmission resonator placed at the coordinates (2,2) outputs the information for generating the first energy signal to the control block 140. Furthermore, the transmission resonator placed at the coordinates (2,2) sends a confirm signal (or a confirm message), checking that the information for generating the first energy signal has been received, to the receiver 200 under the control of the control block 140.

At step 370, the control block 140 generates the first energy signal by controlling the transmission power of the first transmission signal generator 131. Here, the first energy signal is supplied to the transmission resonator placed at the coordinates (2,2) where the receiver 200 is placed through the switch block 120. The control block 140 controls the transmission power of the first transmission signal generator 131 based on a difference between the amount of received energy and the amount of necessary energy in the receiver 200 by communicating with the receiver 200 at specific intervals. The first transmission signal generator 131 can output first transmission energy, corresponding to the amount of necessary energy of the receiver 200, in response to the transmission power controlled by the control block 140. Here, the receiver 200 can send the amount of received energy and the amount of necessary energy to the transmission resonator or can send a difference between the amount of received energy and the amount of necessary energy to the transmission resonator.

Meanwhile, in the apparatus 100 for transmitting wireless energy, an operation of transmitting wireless energy according to the entry of the receiver 200 into the transmission region of the transmission resonator can be classified into an access standby step, an access step, and a wireless energy transmission step.

The access standby step is a step corresponding to the time taken for the apparatus 100 for transmitting wireless energy to detect the entry of the receiver 200 into the transmission region. The access standby step includes the operations of the steps 310 to 350.

The access step is a preparation step in which the apparatus 100 for transmitting wireless energy is prepared to send wireless energy. The access step includes the operation of the step 360.

The wireless energy transmission step is a step in which the apparatus 100 for transmitting wireless energy sends wireless energy to the receiver within the transmission region, and it includes the operation of the step 370.

The apparatus 100 for transmitting wireless energy proceeds to a next step after an operation is completed for each step. Accordingly, after the operation of the access standby step is completed, the access step is performed. After the operation of the access step is completed, the wireless energy transmission step is performed.

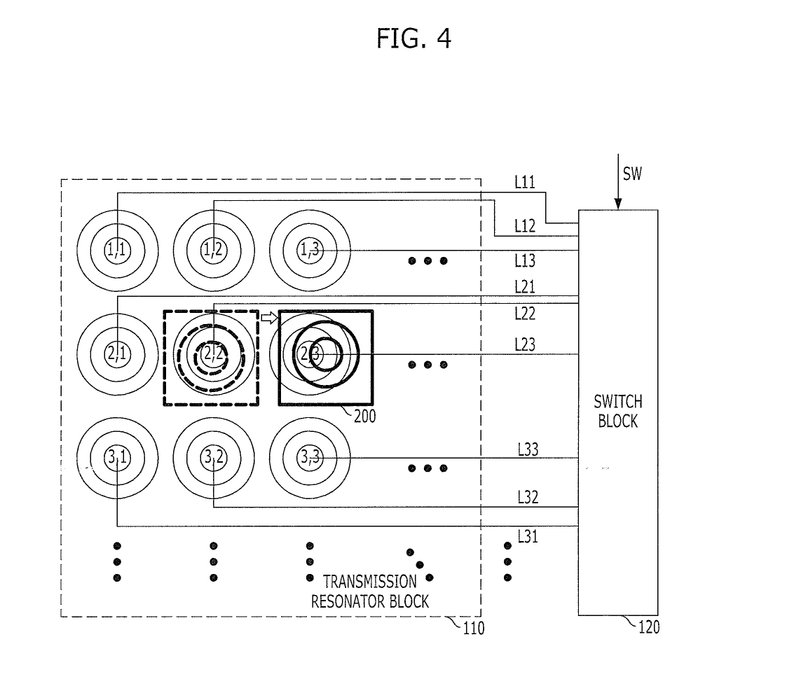

FIG. 4 is a schematic diagram showing the movement of a receiver in the transmission resonator block in the energy transmission system in accordance with an embodiment of the present invention.

Referring to FIG. 4, the switch block 120 is connected to a plurality of transmission resonators through transmission lines L11 to L33 in order to send an energy signal to the transmission resonators. Here, for the connection between the switch block 120 and the plurality of transmission resonators through the transmission lines, reference can be made to the description of FIG. 2.

As in FIG. 2, the receiver 200 can move from the transmission region of a transmission resonator placed at coordinates (2,2) to the transmission region of a transmission resonator placed at coordinates (2,3). When detecting the movement of the receiver 200 from the transmission region of the transmission resonator placed at the coordinates (2,2) to the transmission region of the transmission resonator placed at the coordinates (2,3), the control block 140 sends an energy signal to the transmission resonator placed at the coordinates (2,2) through the transmission line L22 and, at the same time, sends an energy signal to the transmission resonator placed at the coordinates (2,3) through the transmission line L23. Next, when the receiver 200 moves to the transmission region of the transmission resonator placed at the coordinates (2,3), the control block 140 gradually decreases the intensity of the energy signal transmitted through the transmission line L22. Thus, the receiver 200 can receive the energy signal seamlessly.

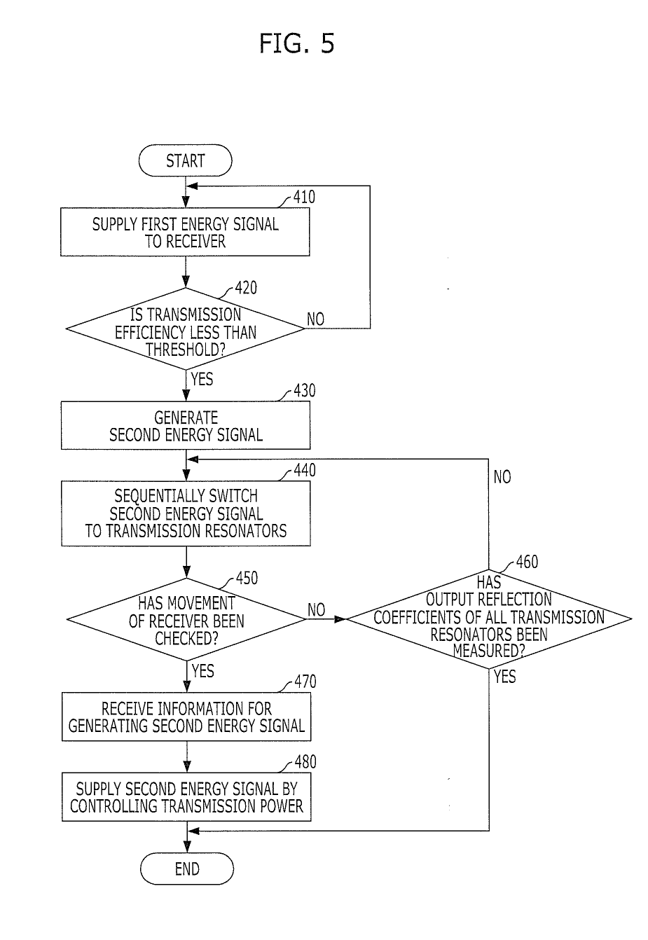

The operation of the apparatus 100 for transmitting wireless energy for providing the energy signal when the receiver 200 moves is described in detail with reference to FIG. 5 below.

FIG. 5 is a schematic diagram showing a process of transmitting wireless energy when a receiver moves in the transmission resonator block 110 in the energy transmission system in accordance with an embodiment of the present invention.

Referring to FIG. 5, at step 410, the control block 140 provides the first energy signal to the receiver 200. At this time, the control block 140 can perform control so that the first energy signal is switched to the transmission line L22 connected to the transmission resonator placed at the coordinates (2,2).

At step 420, the control block 140 determines whether the transmission efficiency of the first transmission signal generator 131 is less than a predetermined threshold or not in response to the transmission of the first energy signal. If, as a result of the determination, it is determined that the transmission efficiency is equal to or greater than the predetermined threshold, the control block 140 proceeds to the step 410. This corresponds to the case where the receiver 200 is placed within the transmission region of the transmission resonator placed at the coordinates (2,2). If, as a result of the determination at the step 420, it is determined that the transmission efficiency is less than the predetermined threshold, the control block 140 proceeds to step 430. This corresponds to the case where the receiver 200 is not placed within the transmission region of the transmission resonator placed at the coordinates (2,2).

At the step 430, the control block 140 switches on the second transmission signal generator 132, thereby generating the second energy signal.

At step 440, the control block 140 controls the switch block 120 so that the second energy signal is sequentially supplied to transmission resonators starting from transmission resonators near the transmission resonator placed at the coordinates (2,2) for a specific period of time. The switch block 120 supplies the second energy signal to all the transmission resonators in order to measure output reflection coefficients.

At step 450, the control block 140 checks whether the receiver 200 has moved or not based on the measured output reflection coefficients. Here, the control block 140 measures the output reflection coefficients sequentially in response to the supply of the second energy signal starting from the transmission resonators near the transmission resonator placed at the coordinates (2,2). Accordingly, the control block 140 performs control so that the second energy signal outputted from the second transmission signal generator 132 has minimum power for measuring the output reflection coefficients.

If, as a result of the check at the step 450, it is checked that the receiver 200 has not moved, the control block 140 proceeds to step 460. If it is checked that the receiver 200 has not moved near the transmission resonator placed at the coordinates (2,2), the control block 140 can check the position of the receiver 200 while gradually widening a region for detecting the movement of the receiver 200.

At the step 460, the control block 140 determines whether the output reflection coefficients of all the transmission resonators have been measured or not. If, as a result of the determination at the step 460, it is determined that the output reflection coefficients of all the transmission resonators have been measured, the control block 140 determines that the receiver 200 is not placed within the transmission regions of the transmission resonators and terminates the operation. Next, the apparatus 100 for transmitting wireless energy operates in the access standby step. If, as a result of the determination at the step 460, it is determined that the output reflection coefficients of all the transmission resonators have not been measured, the control block 140 proceeds to the step 440. Next, the control block 140 checks whether the receiver 200 has moved or not based on the measured output reflection coefficient of a next transmission resonator.

If, as a result of the check at the step 450, it is checked that the receiver 200 has moved, the control block 140 proceeds to step 470. In this case, the control block 140 can detect the receiver 200 that has moved to the transmission resonator placed at the coordinates (2,3). Furthermore, when the movement of the receiver 200 is checked, the second transmission signal generator 132 operates in the access step.

At the step 470, the control block 140 receives information for generating the second energy signal from the receiver 200. The control block 140 supplies the switching control signal. SW to the switch block 120 so that the second energy signal is supplied to the transmission resonator placed at the coordinates (2,3) where the receiver 200 is placed. Here, the intensity of the second energy signal supplied to the transmission resonator placed at the coordinates (2,3) can be increased under the control of the control block 140 until a communication block within the receiver 200 operates. Accordingly, the second energy signal can supply energy for the operation of the communication block, that is, power.

When the communication block operates, the receiver 200 supplies information for generating the second energy signal to the transmission resonator placed at the coordinates (2,3). Here, the information for generating the second energy signal includes information on an IDentifier (ID) of the receiver 200, the amount of necessary energy, and the amount of received energy. Accordingly, the transmission resonator placed at the coordinates (2,3) outputs the information for generating the second energy signal to the control block 140. Furthermore, the transmission resonator placed at the coordinates (2,3) sends a confirm signal (or a confirm message), checking that the information for generating the second energy signal has been received, to the receiver 200 under the control of the control block 140.

At step 480, the control block 140 generates the second energy signal by controlling the transmission power of the second transmission signal generator 132. The control block 140 controls the switch block 120 so that the second energy signal is outputted to the transmission resonator placed at the coordinates (2,3) through the transmission line L23. The control block 140 controls the transmission power of the second transmission signal generator 132 based on a difference between the amount of received energy and the amount of necessary energy in the receiver 200 by communicating with the receiver 200 at specific intervals. The second transmission signal generator 132 can output the second transmission energy, corresponding to the amount of necessary energy of the receiver 200, in response to the transmission power controlled by the control block 140. Furthermore, the receiver 200 can send the amount of received energy and the amount of necessary energy to the transmission resonator placed at the coordinates (2,3) or can send a difference between the amount of received energy and the amount of necessary energy to the transmission resonator placed at the coordinates (2,3).

Meanwhile, the control block 140 gradually decreases the transmission energy (or the transmission power) of the first transmission signal generator 131 depending on a change of transmission efficiency and gradually increases the transmission energy (or the transmission power) of the second transmission signal generator 132.

When the receiver 200 fully moves to the transmission resonator placed at the coordinates (2,3), the control block 140 turns off the power source of the first transmission signal generator 131.

Furthermore, the control block 140 can detect a movement of the receiver 200 while sending wireless energy through the second transmission signal generator 132. In this case, the control block 140 performs control so that the first transmission signal generator 131 repeats the operations of the second transmission signal generator 132 corresponding to the steps 430 to 480.

As described above, the first transmission signal generator 131 and the second transmission signal generator 132 can alternately perform operations depending on a movement of the receiver. Thus, energy can be smoothly transmitted to the receiver 200 on a transmission region that is formed through the transmission resonator block 110. That is, the apparatus 100 for transmitting wireless energy can configure a wireless energy transmission network having a wide area.

The apparatus for transmitting wireless energy in accordance with the present invention can efficiently transmit energy to a wide transmission region out of one transmission resonator region. Accordingly, it is expected that an efficient wireless energy transmission network can be configured for a wide indoor area or an outdoor are.

The apparatus for transmitting wireless energy can include all devices that transmit energy wirelessly, and the receiver can include all electronic devices for households and industry. For example, the receiver can include all electronic devices that require a power source, such as a mobile phone, a tablet Personal Computer (PC), smart Television (TV), a desktop computer, a notebook, a set-top box, a game player, a Portable Media Player (PMP), an electronic picture frame, and a digital camera. The receivers are only for convenience of description, and they include other electronic devices capable of transmitting power other than the above-described electronic devices.

In accordance with the present invention, a plurality of transmission resonators is arranged in the energy transmission system. Accordingly, an energy transmission region can be extended, and a wireless energy transmission network capable of transmitting wireless energy to a wider area can be configured.

While the present invention has been described with respect to the specific embodiments, it will be apparent to those skilled in the art that various changes and modifications may be made without departing from the spirit and scope of the invention as defined in the following claims.

What is claimed is:

1. An apparatus for transmitting wireless energy in an energy transmission system, comprising:
a transmission resonator block configured to have a plurality of transmission resonators arranged therein;
a transmission signal generation block configured to generate an energy signal;
a switch block connected to the plurality of transmission resonators and configured to switch the energy signal to the plurality of transmission resonators in response to a switching control signal; and
a control block configured to generate the switching control signal for switching the energy signal to a transmission resonator including a transmission region where a receiver is placed when detecting the receiver placed in the transmission regions of the plurality of transmission resonators.

2. The apparatus of claim 1, wherein the transmission signal generation block comprises:
a first transmission signal generator configured to generate a first energy signal; and
a second transmission signal generator configured to generate a second energy signal.

3. The apparatus of claim 2, wherein the control block generates the switching control signal for performing control so that the first energy signal is sequentially supplied to the plurality of transmission resonators and detects a position of the receiver based on output reflection coefficients measured in response to the switching control signal.

4. The apparatus of claim 3, wherein the control block detects that the receiver is placed in the transmission region of a transmission resonator having a greatest change in the measured output reflection coefficient.

5. The apparatus of claim 3, wherein the control block performs control so that the first transmission signal generator is switched on and the second transmission signal generator is switched off, while detecting the position of the receiver.

6. The apparatus of claim 3, wherein the control block generates the switching control signal for performing control so that the first energy signal is transmitted to the transmission resonator where the receiver is placed.

7. The apparatus of claim 6, wherein the control block detects that the receiver moves to a transmission region of a different transmission resonator different from the transmission resonator when transmission efficiency according to the transmission of the first energy signal is less than a predetermined threshold.

8. The apparatus of claim 7, wherein the control block generates the switching control signal for performing control so that the second energy signal is sequentially supplied to other transmission resonators near the transmission resonator and detects the position of the receiver based on output reflection coefficients measured in response to the switching control signal.

9. The apparatus of claim 7, wherein the control block detects that the receiver moves to a transmission region of a transmission resonator having a greatest change in the measured output reflection coefficient.

10. The apparatus of claim 7, wherein the control block performs control so that the first transmission signal generator is switched off after the receiver moves to the transmission region of the different transmission resonator.

11. A method of transmitting wireless energy in an energy transmission system, the method comprising:
generating an energy signal;
sequentially supplying the energy signal to a plurality of transmission resonators for a specific period of time;
measuring output reflection coefficients generated in response to the energy signal;
detecting a position of a receiver based on the measured output reflection coefficients; and
supplying the energy signal to a transmission resonator where the receiver is placed.

12. The method of claim 11, wherein in said detecting a position of a receiver based on the measured output reflection coefficients,
what the receiver is placed in a transmission region of a transmission resonator having a greatest change in the measured output reflection coefficient is detected.

13. The method of claim 11, further comprising:
detecting a movement of the receiver when transmission efficiency according to the supply of the energy signal is less than a predetermined threshold;
generating a different energy signal for detecting a position of the receiver;
sequentially supplying the different energy signal to transmission resonators near the transmission resonator for a specific period of time;
measuring output reflection coefficients generated in response to the different energy signal; and
detecting a position of the receiver based on the measured output reflection coefficients and supplying the different energy signal to a transmission resonator of a transmission region where the receiver is placed.

14. A method of transmitting wireless energy in an energy transmission system, the method comprising:
detecting an entry of a receiver into a plurality of transmission regions formed by respective transmission resonators;
receiving information for generating an energy signal that is necessary for the receiver through communication with the receiver when detecting the entry of the receiver; and
sending the energy signal, generated based on the received information, to the receiver.

15. The method of claim 14, wherein the information for generating the energy signal comprises information on an identifier of the receiver, an amount of necessary energy, and an amount of received energy.

16. The method of claim 14, further comprising receiving the information for generating the energy signal from the receiver at a specific interval.
